(19) United States
(12) Patent Application Publication
(10) Pub. No.: US 2007/0151217 A1
(43) Pub. Date: Jul. 5, 2007

(54) Exhaust Gas Particle Filter Made of Sintered Metal

(75) Inventors: Peter Neumann, Menden (DE); Joachim-Christian Claus, Oelde (DE); Carsten Jutka, Menden (DE); Jochen Koll, Arnsberg (DE); Hans-Peter Frisse, Herzogenrath (DE)

Correspondence Address: RICK MARTIN;PATENT LAW OFFICES OF RICK MARTIN, PC, 416 COFFMAN STREET, LONGMONT, CO, 80501, US

(73) Assignees: HJS FAHRZEUGTECHNIK GMBH CO KG, Menden (DE); PUREM ABGASSYSTEME GMBH. CO. KG, Unna (DE)

(21) Appl. No.: 11/627,702

(22) Filed: Jan. 26, 2007

Related U.S. Application Data
(63) Continuation-in-part of application No. 10/481,368, filed on Jun. 15, 2004.

(30) Foreign Application Priority Data
Jun. 18, 2001 (DE) 101 28 937.7
Jun. 18, 2001 (DE) 101 28 937.5

(51) Int. Cl. B01D 39/20

(52) U.S. Cl. 55/523

(57) ABSTRACT

The invention relates to an exhaust gas particulate filter made of sintered metal for removing particulates contained in the exhaust gas stream of an internal combustion engine, particularly of a diesel internal combustion engine. The exhaust gas particulate filter is made of a filter material having at least one metal support (1), which has openings (O). The openings (O) are bounded by segments (S), which are tilted in respect to the outer surface planes of the support (1). The openings (O) are filled with sinter metal powder The support (1) consists of an expanded metal, and the sections delimitating the openings (O) of the support (1) are joined to one anther with a material bond forming nodes (K). The sintered metal powder filling of the openings (O) is arranged in a substantially flush manner with the outside surfaces of the support (1).

### CROSS REFERENCE APPLICATIONS

This application is continuation in part of application Ser. No. 10/481,368 filed Jun. 15, 2004 which is a national phase application claiming priority from PCT application no. PCT/EP02/05763 filed on 25 May 2002 and claiming priority from German application 101 28 937.7 filed on 18 Jun. 2001 and from German application 101 28 937.5 filed on 18 Jun. 2001.

### FIELD OF INVENTION

The present invention relates to an exhaust gas particulate filter for the elimination of particulates contained in the exhaust gas stream of an internal combustion engine, in particular a diesel engine. The particulate filter is made of metal with at least one metal support including openings to which porous sinter metal is bound in a sintering process.

### BACKGROUND

Sintered metal filters are employed as exhaust gas particulate filters for internal combustion engines, for example for diesel internal combustion engines, to eliminate particulates, such as soot particles, contained in the exhaust gas stream. The exhaust gas particulate filters are mounted in the exhaust gas train of the engine and must be capable of withstanding the temperatures of the exhaust gas flowing through the exhaust gas particulate filters and also the temperatures generated during a soot burn-off for regenerating such an exhaust gas filter. Sintered metal filters fulfill these requirements. The sintered metal filters are produced by shaping filter material strips to form filter plates or filter pockets from which the filter body is fabricated.

The prior art filter strips are often made with a wire fabric as a support material. The wire fabric is coated with a sinter metal powder and then subjected to a sintering process. With this process sintered metal plates can be produced which have a porosity of approximately 50% to 80%. To form the filter body proper it is necessary to connect the individual reshaped filter plates or filter pockets together, by welding or other methods.

Such a sintered metal filter, in which a wire fabric is utilized as a support, is described in EP 0 505 832 B 1. To improve the heat distribution, in particular the heat dissipation during welding of the sintered metal material, twill wire fabric serves as a support. Compared to otherwise customary wire fabrics, a twill wire fabric is distinguished in that in order to increase the contact points of the individual wires among themselves additional wires are woven into the fabric, of which one weft wire bridges several warp wires. Compared to other wire fabrics, with the twill fabric the heat transfer between individual wires is improved by increasing the heat transfer sites through the increased number of contact points between the individual wires. However, its rigidity and its weight also increase due to the additional wires for forming the fabric. This, in turn, has a disadvantageous effect on the necessary reshaping process required for producing filter plates or filter pockets. Higher reshaping forces are required compared to such filter material sections produced with other fabrics as the support material. It may therefore occur that the sinter material applied onto the twill wire fabric is damaged or even spalls off, due to the fact that its strength properties are reduced through the porosity relative to the support material and the necessary forces which must be made available for carrying out the reshaping process.

A further drawback of sintered metal filters using a wire fabric as support structure is their weight. Since sintered metal filters of the kind are also used in the exhaust gas system of automobiles, weight is an important issue. In particular, when applying such filter in the exhaust gas system of a heavy duty diesel truck, these filters need to have a rather large filtering surface, which may only be achieved with large filters. Due to the weight, it is necessary to arrange the filters in special bearings to compensate vibrations and/or thermal stress. The weight of such filters should not be excessive to prevent secondary problems.

DE 195 20 146 C1 describes a method for the production of porous bodies, for example of exhaust gas particulate filters. In a first step a support material is reshaped before it is coated by flame spraying until the openings in the support material have become obstructed. Consequently, this document teaches to shape first the support material of the filter plate or of the filter pocket into its appropriate shape and then to coat this shaped body with the filter material proper. Apart from the fact that this method is unsuitable for producing sintered metal filters, using this method for the production of sintered metal filters would at best yield the advantage that during the reshaping, compared to other methods, the sinter metal layer applied on the support and the welding to produce the filter body of individual previously reshaped parts would be avoided.

However, exhaust gas particulate filters with filter chambers or filter pockets, which only have an opening width of a few millimeters or if formed as a wedge filter even taper, cannot be produced with the method described in this publication. Moreover, the danger exists that the connection between the support and the applied material is also damaged due to the large temperature fluctuations at exhaust gas and regeneration temperatures compared to the temperatures when not in operation.

EP 0 166 606 B1 discloses a porous metal object which can be employed as a filter. In this porous object a metal support with openings serves as a support for the sinter metal powder. In order to coat the support with sinter metal powder the support is run through a stabilized suspension of a dispersed metal particulate in a fluid medium. According to this prior art, the sintered metal powder dispersed in the slurry will coat the support and fill the openings of the support. After exiting the slurry, the complete support structure will be covered with sintered metal powder. With the method described in EP 0 166 606 B1 the width of the openings of the support structure have to be big enough that slurry material will flow into them while the structure is been drawn through the slurry. On the other hand the openings may not exceed a certain size, because then the segments bounding the openings could be coated with sintered metal powder without the openings being completely filled.

According to this prior art, it is necessary to run the structure through the slurry a couple of times to thicken the sinter metal coating and finally closing the openings by filling the openings with sintered metal powder. Therefore, according to this prior art, it is not possible to use support structure with rather large openings and produce a filter sheet with minimum thickness. In this document as support structures wire mash and cloth are mentioned as possible support structures. Also the possible use of expanded sheet metal is disclosed. In the light of the forgoing it is thus understood that when expanded sheet metal is used as support structure it may only have very small openings if the sinter metal sheet shall not exceed a certain thickness.

During the process of sintering the metal power becomes caked with itself and with the support. Sheet metal with openings, regardless of the properties, have been described as a support for forming this filter material, and in this document expanded metal as a support equivalent to an otherwise customarily utilized wire fabric is also mentioned. Subject matter of this document is the filling of the openings of the support with a suitable metal powder in order to provide a metal filter with which fine-grained particles can also be removed from a mass flow. However, this document does not disclose that it could be useful to utilize a filter body produced according to the method described in this document as a sintered metal filter for eliminating particulates contained in the exhaust gas stream of an internal combustion engine. This document consequently also does not disclose any references to the manner in which such sintered metal filters could be formed appropriately.

In GB 656,292 an improvement to filters is disclosed. The filter disclosed in this document comprises a sintered mass of powdered metal having a high degree of porosity in association with a perforated metal sheet, with the perforations therein having been reduced in size by a rolling process. Thus according to the embodiment described in GB 665,292 the openings of the perforated metal sheet are small so that the openings are capable of retaining sintered metal powder. If the opening is too big, a perforated metal sheet may be located within the body of the sintered mass such that sintered metal powder will be retained in an opening. Alternatively, the sintered mass may be contained in the perforated metal sheet and at the same time other strengthening sheet metal may be located within the body of the mass. According to this document, the supports can be perforated sheets which may or may not have been rolled, expanded metal, or wire gauze or cloth. The use of expanded metal according to this document is thus to use this metal sheet and coat both sides of it with sintered metal powder. This support structure is thus over all covered with sintered metal powder. This filter encounters the same drawbacks as described before.

Building on the previously discussed prior art, the invention therefore addresses the problem of further developing a sintered metal filter such that the filter material employed for structuring the sintered metal filter for providing different sintered metal filter bodies is not only reshapable quasi like a solid material but also can be welded more easily and shows improvements in respect to the weight to filtering surface ratio.

### SUMMARY

The primary aspect of the present invention is to provide a sintered metal particulate filter for internal combustion engines.

The sintered metal particulate filter is formed with the support of the particulate filter is an expanded metal, of which the openings are bounded by segments and these are materially connected with one another. The segments bounding the openings of such expanded metal are typically inclined, in relation to the outside planes of the expanded metal being used as support structure. The inclination of the segments binding the opening allows the sintered metal powders in the openings of the expanded sheet metal to be securely clamped to the segments. It is not necessary to fix the sintered metal powder filing the openings to the structure to link the fillings of the openings to one another by coating at least one of the outside planes of the support structure. Thus, the sintered metal powder filling the openings is arranged in a substantially flush manner with the outside planes of the support. This allows the filter sheet material to be manufactured rather thin, thus reducing the weight of the particulate filter without having to compensate for drawbacks in respect of the filtering quality.

According to the disclosure the thickness of such filter metal sheet may be defined by the layers of sintered metal particles in the direction of the depth of a filling needed for the filtering process and not by the structure supporting the sintered metal powder to which the thickness of the filter layer needs to be added. In order to obtain a sufficient filtering quality of exhaust gases of diesel combustion engines it has been encountered, that about 8 to 15 sintered metal powder particle layers are sufficient.

When using expanded sheet metal as support structure in an exhaust gas particulate filter as claimed it is possible to vary the width of the openings very easily during the manufactured process of the expanded metal. This allows the production of a support structure where the section with the openings is bordered by a metal strip without openings. The strip without openings may be used as the rim of a filter sheet giving it a higher strength and supplying more material for a welding process. Filter pockets made of such filter sheet material using an expanded sheet metal with a rim section without openings also strengthens the shape of such a filter pocket. Typically a certain amount of filter pockets are arranged to build up the exhaust gas particulate filter. It will be well understood, that such inventive step also be use for any other kind of filtering structure, which not necessarily need to be filter pockets as described.

Expanded sheet metal as a support structure in such sintered metal particulate filter also gives advantages in the process of filling the openings. The segments bounding the openings of the support structure of the invention are inclined. The inclined segments may be used like a shovel directing sintered metal powder into the openings and as blade, from which excessive sintered metal powder may be scrapped off. Therefore, the openings may easily be filled by way of a different process in respect to the one described in EP 0 166 606 B1. In an alternative filling process an expanded metal strip is run through a filling station comprising a container with sinter metal powder which is brought into the openings as the expanded sheet metal passes through the powder. Downstream to the filling container a scraper can be arranged resting on the top side of the segments bounding the openings of an expanded sheet metal, thus scraping of excessive sinter metal powder. With such arrangement the top side and downside surface of the expanded sheet metal strip is not covered with sinter metal powder. The sintered metal powder filter sheet is then defined by the thickness of the expanded metal, which in turn is adapted with its thickness according to a preferred embodiment to the amount of layers needed in a filtering wall of a filter body, for example a filter pocket.

In the light of the prior art, it was surprisingly for the inventors to encounter that the sintered metal powder would be clamped to the segments in a manner so thoroughly when the powered only filled the openings. Further, it was surprising to encounter the strength of such sintered filter sheet when such filter sheet is undertaken to a bending process, even if such bending is carried out with very small radii. Also, the sintered metal powder in the openings does not chip out when bending such sintered filter sheet material. The bending work may be concentrated to the segments and nodes of the expanded sheet metal as support structure.

In the disclosed sintered metal filter the support comprises a material forming a material unit, namely an expanded metal. Due to its material unity, an expanded metal as the support has the advantage that the heat distribution within the filter, and consequently the heat dissipation during welding, and also during the regeneration of the sintered metal filter, is improved in comparison to the published prior art heat transfers. The formation of the support's expanded metal has further advantages during reshaping, in particular if stamping to form reinforcing creases or the like are to be produced. In contrast to published prior art, there is little risk that individual wires of a fabric are displaced with respect to one another during to the reshaping process due to the material unity in such sintered metal element. This displacement could cause spalling off or spalling out of sintered metal. Consequently, this support material is highly dimensionally stable, especially during the reshaping process. The support for the sintered material can have a relatively large opening width without sacrificing the heat distribution or heat dissipation, which favourably affects the exhaust back pressure, since the area component of the support material can be reduced on the filter surface.

After the expansion process the expanded metal is calendered and specifically by no more than 70%. This ensures that even after the calendering process, the webs of the expanded metal provide for the encompassed openings a sufficient abutment area, so that sintered metal included in the openings is held form-locked in them. In particular, in order to meet the requirements during the specified application of the sintered metal filter.

The ratio of weight of the support and sintered metal taking part in the structuring of the filter material is usefully less than 3:7 of support: sintered metal. This ratio is preferably between 2:8 and 1:9, and with these ratio specifications it is assumed that sintered metal powder is only in the openings of the support. However, if very high requirements are made of the stability of the exhaust gas particulate filter, it is entirely possible for a ratio of approximately 1:1 to be utilized. The formation of a filter material with such a small support material component is not realizable with conventional supports of fabrics, at least not with the strength obtained with the filter material according to the invention.

Of special advantage when using an expanded metal as a support is that since the integral upper and lower closure of the individual regions defines an opening, the sintered material does not need to form a continuously statically effective layer on the support. Rather the sintered material only needs to be introduced into the opening of the support. This not only reduces the quantity of the required sinter metal powder, but it has the advantage that during the reshaping the webs of the expanded metal located between the openings are reshaped and not, or only secondarily, the sintered material introduced into the opening. Therefore reshaping steps, such as a turning on edge by 90° or even 180°, may be carried out without the danger that the sintered material introduced into the openings breaking out. Such turning on edge may be required to reinforce the margin region of a filter plate or also to be able to form a material thickening for the subsequent welding.

Another advantage is that during the expanding process the openings necessary for forming mesh-form structures can have different dimensioning with a support of expanded metal. This can be attained through the degree of expansion and/or by introducing different incisions before the expansion process proper. In this way, elements for a sintered metal filter can be provided, which have a different opening geometry as a function of their disposition within the sintered metal filter body.

When using an expanded metal as the support it is possible to specify the slope of the webs for holding the sintered metal fillings through the degree of expansion, apart from the opening width of the openings of the support. The thickness can also be adjusted via the step of calendering. Consequently the same starting material can be used in to produce filter material strips of different formation. The thickness of such a filter material strip is determined by the degree of elevation of the webs of the support bounding the openings, so that filter material strips can be produced which have a thicker gauge, without the support material component of the total weight of the filter material strip increasing excessively. This is in contrast to fabrics in which the thickness is determined by the thickness of the wire employed.

These and other features and advantages of the exhaust filter reside in the construction of parts and the combination thereof, the mode of operation and use, as will become more apparent from the following description, reference being made to the accompanying drawings that form a part of this specification wherein like reference characters designate corresponding parts in the several views. The embodiments and features thereof are described and illustrated in conjunction with systems, tools and methods which are meant to exemplify and to illustrate, not being limiting in scope.

### BRIEF DESCRIPTION OF THE DRAWINGS

FIG. 1 is a schematic representation of a section of a support of a filter material for the formation of a sintered metal filter. FIG. 2 is a schematic section along line A-B through an enlarged section of the support of FIG. 1, whose openings are filled with sintered metal powder. FIG. 3 is a diagram showing the calculated heat conductivity of a filter sheet material as incorporated into the particulate filter according to the invention compared with a filter sheet material according to prior art.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE DRAWINGS

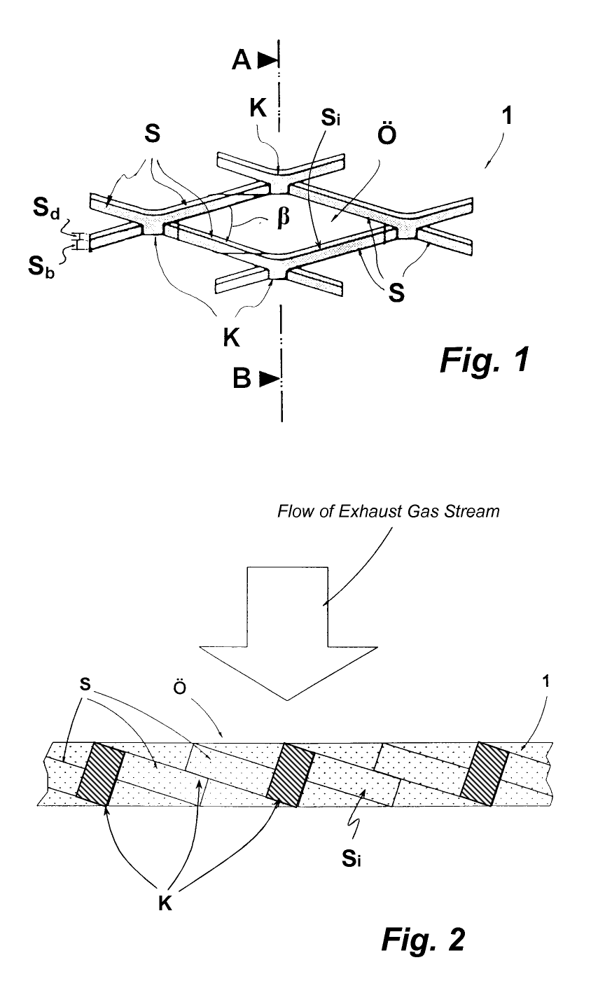

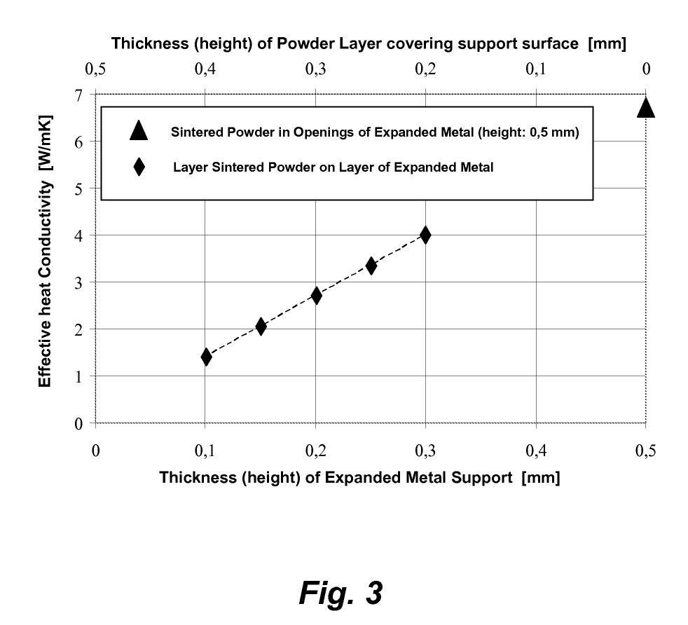

FIG. 1 shows a support 1 for forming filter material for a sintered metal filter to eliminate particulates contained in the exhaust gas stream of a diesel internal combustion engine produced of expanded metal. The support 1 is made from a steel sheet as the starting material. Incisions are introduced into the sheet for producing the openings by way of the expansion process. In the course of an expansion process the steel sheet has been brought into the form shown in FIG. 1, and the incisions originally introduced into the steel sheet have widened to form openings O. The openings O are bounded by segments denoted as segments S of the original steel sheet, which join in those regions of the support in which the incisions terminate. These regions are denoted as node points K. All segments S of support 1 are consequently in material connection via the node points K. This permits the formation of a support which not only ensures an especially good heat dissipation and heat distribution, but which also is able to show a very high stability which is uniform in different directions.

The opening angle β between two segments S separated by an incision is usefully in the range between 40° and 80°, preferably between 50° and 70°. At smaller opening angles the ratio between the area of the opening O to the total area of the expanded metal as support structure and the surface of the sintered metal filter sheet respectively is not as good as with opening angles defined before, since then the filter material would offer too high an exhaust gas back pressure.

The structure of support 1 is evident at an enlarged scale in the cross section of FIG. 2. The depicted section line intersects several node points K, from which one segment S each extends to the next node point K. The segments S themselves, as shown by node point K, are tilted and form openings O with inclined side faces. These inclined side faces permit an especially good bracing of the sintered metal introduced therein, as is indicated in FIG. 2. Each opening 0 is filled with sintered metal, and the cross section depicted in FIG. 2 shows that the sintered metal fillings are each held form-locked in an opening O provided by support 1.

The form-locked arrangement of the sintered metal powder to the segments may be upgraded if the segments S are torqued during the expanding process relative to the nodes K. This results in an inclined face Sᵢ of the segments S and brings the corner into the opening O, which is then embraced by sintered metal powder. Consequently the support 1 with its openings O offers good mechanical bracing properties and an effective abutment, such that there is no danger that the sinter material introduced into the openings is pressed out of the individual openings, due to a pressure difference between the up-stream filter side and the down-stream side filter side or due to a deformation of the sintered metal sheet to form filter pockets. The sintered metal fillings are consequently insular aggregates, each received in the openings O of support 1. As well been seen from FIG. 2 the sintered metal powder filling the openings O is in substantially flush arrangement with the outside planes of the support 1.

The segments S bounding the openings O of the embodiment depicted show an inclination in respect to the outside plane of the structure of approximately 17°. The inclination of the segments S is basically dependent on the opening angle β.

The gauge of the original steel sheet for forming the support 1 corresponds to the narrow side of a node point K between the segment thickness Sd. The ratio of segment width S_{b} to segment thickness S_{d} is usefully 1. At such a ratio the segments are square on cross section. To be able to attain adequate form-locking with the sintered metal, the segments can also have segment width S_{b} to segment thickness S_{d} ratios between 0.5 and 2.0. Depending on the before mentioned ratio when expending the sheet metal the inside surfaces Sᵢ are turned around the longitudinal axes of the segments S, thus giving a further surface, on which the sinter metal may be form locked in an opening O.

The proximal mechanical connection of the segments S and node points K participating in the structure of support 1 make clear that the support 1 is capable of withstanding high mechanical stresses. Sᵢ nce support 1 forms a material unit and is more readily deformable relative to the sintered metal, a reshaping takes place primarily at the segments S and the node points K in the event that the filter material is reshaped for example by turning on edge or by embossing reinforcing creases. The segment width S_{b} is adjusted in such a manner that when deforming the sintered metal sheet, the nodes K and/or the segments S are deformed, leaving the form locked sintered metal powder fillings of the openings more or less undeformed. Deformation is undertaken to such sintered metal filter sheet when building up a filter body or a part of such filter body, for example a filter pocket. Such filter pockets are disclosed in U.S. Pat. No. 7,029,510 B2 or U.S. Pat. No. 7,044,992 B2, which are incorporated by reference to the extent not inconsistent with the disclosure herein.

To improve the bonding properties between the sinter metal powder during the sintering and the support, it is advisable to provide the surface of the support 1 with texturing, for example a microtexturing, produced by chemical treatment or a jet process involving particles. Through such a jet process moreover a certain intrinsic tension can be built into the support (tension beams) which has a favorable effect on its strength. With such a measure the effective surface of the support is increased, especially in the side faces directed toward one another, of the segments S bounding the openings O, such that a bracing of the sintered metal powder on the segments S of the support 1 is possible.

The grain fraction or particle size of the sinter metal powder employed is dimensioned such that 8 to 15 layers of powder should be provided in order to fill out an opening O of support 1 in the direction of the gauge of support 1. Thus the height or thickness respectively of the sintered metal sheet, and thus the thickness of the material of each filter pocket, is basically defined by the number of sintered metal powder layers in order to achieve the desired filtering result. However, for the formation of sintered metal filters to eliminate the particulates contained in the exhaust gas stream of an internal combustion engine, it has been found to be sufficient to fill the openings O of support 1 with sinter metal powder of a grain size such that maximally 15 powder layers are provided in the direction of the thickness of the filter material formed therefrom.

As the starting material a steel sheet having a gauge of 0.2 mm can be used. Depending on the configuration and disposition of the incisions, after carrying out the expansion process, the thickness of the support formed therefrom can be 3 mm. It should be noted that regardless of the thickness during the expansion process, the support weight does not increase. If required, the expanded material can be calandered, for example to a thickness of 0.9 mm, which corresponds to a calandering of 70%. The calendaring of an expanded sheet metal done not only to reduce its thickness, but also to provide segments S bounding the openings O with a certain width. According to a preferred embodiment, the thickness of a sintered sheet metal to manufacture sintered metal filter pockets for an exhaust gas particulate filter is about 0.5 mm.

For an exhaust gas particulate filter it is important that it have a uniform heat distribution and a good heat conductivity. Filters for the exhaust gas stream of a diesel combustion engine need to be regenerated from time to time. During such regeneration process the soot accumulated on the filtering surface is run through an oxidation process. The process of burning the soot is exothermal. Therefore it is important that the particulate filter has a heat conductivity sufficient to transport the heat generated by such soot burning process to distribute the heat generated over the whole particulate filter to reduce thermal stress and to bring the heat away from the filter body in order prevent any damage to the filter if such soot burning process exceeds certain temperatures. With the invention claimed, in which the thickness of the support structure is equivalent to the thickness of the sintered metal sheet material, this thickness is approximately the thickness of the heat transporting segments bounding the openings. The height S_{d} of the segments S bounding the openings O are important next to the widths of a segment S in order to define the heat conductivity of such sintered metal filter sheet. The heat conductivity of dense steel used for the expanded sheet metal support structure is a lot better than the heat conductivity of the sintered metal powder. The heat conductivity of sintered metal powder is about 0.097 W/mK and the heat conductivity of dense steal is about 15 W/mK The diagram in FIG. 3 shows the heat conductivity of a sintered metal filter sheet according to the invention with sintered metal powder in the openings only is a lot better compared to a sintered metal filter sheet which is coated on one side with sintered metal powder. The thickness (height), the both sintered metal filtering sheets is 0.5 mm. The diagram has been calculated with a support structure of expanded sheet metal with an opening angle β of 90° and a width of the segments bounding the openings of 0.4 mm. The diagonal extension of each opening is 2 mm. The calculated porosity of the sinter metal powder is 70%. The comparison depicted in FIG. 3 shows the advantages in terms of heat conductivity of the particulate filter of this invention.

Heats conductivity of a sintered metal filter according to the invention with a support structure of expanded sheet metal is much better compared to a particulate filter with wire mesh as support structure which is also due to the larger cross sectional area of the segments bounding the openings when comparing support structures of the same thickness. The cross section area of the segments of an expanded sheet metal is rectangular or square like whereas the cross section area of a wire is round. Thus the space at hand is better used when using an expanded sheet metal as support structure.

Although the present invention has been described with reference to the disclosed embodiments, numerous modifications and variations can be made and still the result will come within the scope of the invention. No limitation with respect to the specific embodiments disclosed herein is intended or should be inferred. Each apparatus embodiment described herein has numerous equivalents.

### LIST OF REFERENCE SYMBOLS

1 Support
K Node point
O Opening
S Segment
S_{b} Segment width
S_{d} Segment thickness
Sᵢ tilted segment surface β Opening angle

1. An exhaust gas particulate filter of sintered metal for eliminating: particulates contained in the exhaust gas stream of an internal combustion engine comprising:
a filter material with a support formed from an expanded metal having openings bounded by segments, wherein the segments bounding the openings of the support are materially connected with one another forming nodes, and wherein the segments bounding the openings are tilted in respect to the outer surface planes of the support;
porous sinter metal powder filled into the openings of the support and sintered to the support thus producing a sintered metal filter sheet;
wherein the sintered metal powder fills the openings of the support, such that it is substantially flush with the outside planes of the support.

2. The exhaust gas particulate filter as claimed in claim 1, wherein the segments bounding the openings enclose an angle of 30° or less with the outside surface plane of the support.

3. The exhaust gas particulate filter as claimed in claim 1 or 2, wherein the faces Sᵢ of the segments bordering an openings are torqued in respect of the nodes.

4. An exhaust gas particulate filter of sintered metal for eliminating particulates contained in the exhaust gas stream of an internal combustion engine comprising:
a filter material with a support formed from an expanded metal having openings bounded by segments, wherein the segments bounding the openings of the support are materially connected with one another forming nodes, and wherein the segments bounding the openings are tilted in respect to the outer surface planes of the support;
porous sinter metal powder filled into the openings of the support and sintered to the support thus producing a sintered metal filter sheet;
wherein the sintered metal powder fills the openings of the support, such that it is substantially flush with the outside planes of the support,
wherein the sintered metal powder fills the openings, such that it is substantially flush with the outside planes of the support; and
wherein the support is calandered after the expansion and before filling the openings with sintered metal powder process.

5. The exhaust gas particulate filter as claimed in claim 4, wherein the amount of calendaring is less than 70%.

6. The exhaust gas particulate filter as claimed in claim 4 or 5, wherein the support has not been calandered by more than 50%.

7. The exhaust gas particulate filter as claimed in claim 4, wherein the segments bounding the openings enclose an angle of 30° or less with the outside surface plane of the support.

8. The exhaust gas particulate filter as claimed in claim 4 or 7, wherein the faces Sᵢ of the segments bordering an openings are torqued in respect of the nodes.

9. An exhaust gas particulate filter of sintered metal for eliminating particulates contained in the exhaust gas stream of an internal combustion engine comprising:
a filter material with a support formed from an expanded metal having openings bounded by segments, wherein the segments bounding the openings of the support are materially connected with one another forming nodes, and wherein the segments bounding the openings are tilted in respect to the outer surface planes of the support;
porous sinter metal powder filled into the openings of the support and sintered to the support thus producing a sintered metal filter sheet;
wherein the sintered metal powder fills the openings of the support, such that it is substantially flush with the outside planes of the support.
wherein the ratio of weight of the support to that of the sintered metal is less than 3:7 relative to the total weight of the filter material.

10. The exhaust gas particulate filter as claimed in claim 9, wherein the ratio of weight of the support to that of the sintered metal is between 2:8 and 1:9 relative to the total weight of the filter material.

11. The exhaust gas particulate filter as claimed in claim 9, wherein the segments bounding the openings enclose an angle of 30° or less with the outside surface plane of the support.

12. The exhaust gas particulate filter as claimed in claim 9 or 11, wherein the faces Sᵢ of the segments bordering an openings are torqued in respect of the nodes.

13. The exhaust gas particulate filter as claimed in one of claims 1, 4, or 7, wherein the exhaust gas particulate filter is comprised of more than one elements of the filter material whose margin segments to be connected are reshaped by at least one turning-on-edge processes.

14. The exhaust gas particulate filter as claimed in one of claims 1, 4 or 7 wherein the elements of the exhaust gas particulate filter are stamped by a stamping process, for example for the formation of reinforcing creases or reinforcing elements.

15. An exhaust gas particulate filter of sintered metal for eliminating particulates contained in the exhaust gas stream of an internal combustion engine comprising:
a filter material with a support formed from an expanded metal having openings bounded by segments, wherein the segments bounding the openings of the support are materially connected with one another forming nodes, and wherein the segments bounding the openings are tilted in respect to the outer surface planes of the support;
porous sinter metal powder filled into the openings of the support and sintered to the support thus producing a sintered metal filter sheet;
wherein the sintered metal powder fills the openings of the support, such that it is substantially flush with the outside planes of the support,
wherein the thickness of the support employed is laid out in adaptation to the number of layers of sintered metal powder needed to be an opening to effect appropriate filtering.

16. The exhaust gas particulate filter as claimed in claim 15, wherein the sintered metal powder filling of the openings each comprises approximately 10 to 15 powder layers.

17. The exhaust gas particulate filter as claimed in claim 15, wherein the segments bounding the openings enclose an angle of 30° or less with the outside surface plane of the support.

18. The exhaust gas particulate filter as claimed in claim 15 or 17, wherein the faces Sᵢ of the segments bordering an openings are torqued in respect of the nodes.

19. The exhaust gas particulate filter as claimed in one of claims 1, 4, 9, or 15, wherein an opening angle of the opening of the support is between 40° and 80°.

20. Exhaust gas particulate filter as claimed in one of claims 1, 4, 9, or 15, wherein the ratio between segment width (S_{b}) and segment thickness (S_{d}) of the support is between 0.5 and 2.0.

21. The exhaust gas particulate filter as claimed in claim 20 wherein the ratio between segment width (S_{b}) and segment thickness (S_{d}) of the support is approximately 1.0.

22. Exhaust gas particulate filter as claimed in one of claims 1, 4, 9 or 11, wherein the surface of the support is textured, in particular microtextured, to improve the bracing between the sintered metal and the support.
